(19) United States
(12) Patent Application Publication
(10) Pub. No.: US 2013/0282343 A1
(43) Pub. Date: Oct. 24, 2013

(54) METHOD AND SYSTEM FOR USE IN MEASURING IN COMPLEX PATTERNED STRUCTURES

(71) Applicants: Boaz Brill, Rehovot (IL); Boris Sherman, Rehovot (IL)

(72) Inventors: Boaz Brill, Rehovot (IL); Boris Sherman, Rehovot (IL)

(73) Assignee: NOVA MEASURING INSTRUMENTS LTD., Rehovot (IL)

(21) Appl. No.: 13/978,066

(22) PCT Filed: Jan. 3, 2012
(86) PCT No.: PCT/IL2012/050003

§ 371 Date: Jul. 2, 2013

(30) Foreign Application Priority Data
Jan. 3, 2011 (US) 61429195

(51) Int. Cl. G06F 17/50

(52) U.S. Cl. CPC G06F 17/50
USPC 703/2

(57) ABSTRACT

A method and system are presented for use in measuring in complex patterned structures. A full model and at least one approximate model are provided for the same measurement site in a structure, said at least one approximate model satisfying a condition that a relation between the full model and the approximate model is defined by a predetermined function. A library is created for simulated data calculated by the approximate model for the entire parametric space of the approximate model. Also provided is data corresponding to simulated data calculated by the full model in selected points of said parametric space. The library for the approximate model data and said data of the full model are utilized for creating a library of values of a correction term for said parametric space, the correction term being determined as said predetermined function of the relation between the full model and the approximate model. This enable to process measured data by fitting said measured data to the simulated data calculated by the approximate model corrected by a corresponding value of the correction term.

### FIELD OF THE INVENTION

This invention is generally in the field of optical measurement techniques, and relates to system and method for use in measuring in complex patterned structures by solving inverse problems.

### BACKGROUND

There are various applications in which parameters of complex structures cannot be measured directly, and measurement technique therefore utilizes solving of inverse problems. An example of such measurement technique is scatterometry applied to complex patterned structures. Optical CD models become increasingly complex as scatterometry measurements are applied to complex in-die applications in both R&D and high-volume manufacturing. One of the main challenges of scatterometry modeling is an exponential growth in required computation time due to the increasing complexity of the applications, requiring increasing number of model parameters, shift to 3D vs. 2D structures, larger number of modes, larger, more complex unit cells etc.

One of the common practices in scatterometry is to avoid the need to calculate diffraction spectra in real time by pre-calculating a representative set of diffraction spectra, storing it in a database (library) and later using it in real time in order to interpret the measured results. As model complexity increases, also library generation time becomes larger, creating a limiting factor for the time that is required to generate a working recipe for a new application.

### GENERAL DESCRIPTION

There is a need in the art for a novel approach in measuring in complex structures, capable of reducing the calculation time at the library creation stage and also providing for faster real-time measurements of the structure parameters.

The present invention provides a novel technique for use in measuring in complex patterned structures, which is based on a so-called “decomposition approach”. It should be understood that for the purposes of the present application, the term “complex patterned structure” refers to a structure with a complex geometry (pattern features) and/or material composition such that a relation between the structure to parameter(s) and an optical response of the structure (e.g. spectra) to incident light cannot be easily modeled. The latter means that such relation between the structure parameter(s) and response cannot be directly defined by a single model (single function) enabling a meaningful calculation time for the library creation and/or processing of measured data.

According to the invented technique, two or more models are defined for the same measurement site. The models include a full model (FM) and at least one approximated model (AM). The full model contains a sufficiently complete geometrical description of the problem, adequate spectral settings, all relevant parameters floating, etc., as is usually defined in the standard approach. The approximated model is some approximation of the same problem, allowing faster calculation time while still retaining most essential properties of the problem. The approximated model is selected such that for a given full model, the full model and the approximation model are characterized by a certain well defined relation between them (e.g. difference between the full model and approximated model), e.g. a smooth function in the simplest example or a linear function in an optimal case.

It should be understood that the minimal set of parameters is that of the approximation model, while the full model includes said set and additional parameters. The parametric space (parameters' set) defining the approximation model, and accordingly included in that of the full model, includes parameters of the structure (e.g. features of the pattern, layers, etc.) and/or parameters/conditions of the response from the structure (e.g. collected diffraction pattern, numerical aperture of response detection, wavelengths, etc.).

It should be noted that the technique of the invention utilizes library creation for the structure responses varying within the same parametric space (a set of parameters). The library creation may be a fully off line stage, i.e. independent of actual measurements on the structure to be monitored, or may also include an on line refinement stage for updating/modifying during the actual measurements.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram of an example of a system of the invention for use in measuring in complex patterned structures;

FIG. 2 is a flow diagram of an example of a method of the invention carried out by the system of FIG. 1;

FIG. 3 shows an example of the invention utilizing approximation by lateral separation of different patterns;

FIG. 4 shows an example of the invention utilizing approximation by vertical interaction of buried (patterned) underneath layers in a multi-layer structure;

FIG. 5 shows an example of the invention utilizing approximation by a reduced unit cell;

FIG. 6 shows an example of the invention utilizing approximation by improved symmetry;

FIG. 7 shows an example of the invention utilizing approximation of double patterning; and

FIG. 8 shows an example of the invention utilizing rough approximation of profile with lower number of slicing.

### DETAILED DESCRIPTION OF EMBODIMENTS

The present invention provides a system and method for use in measuring in complex patterned structures, based on a decomposition approach. According to this approach, two or more models are defined for the same measurement site including a full model (FM) and at least one approximated model (AM). While this approach can be easily extended to multiple approximation models, for the sake of simplicity only the case of two models is considered below: a full model and a single approximation model.

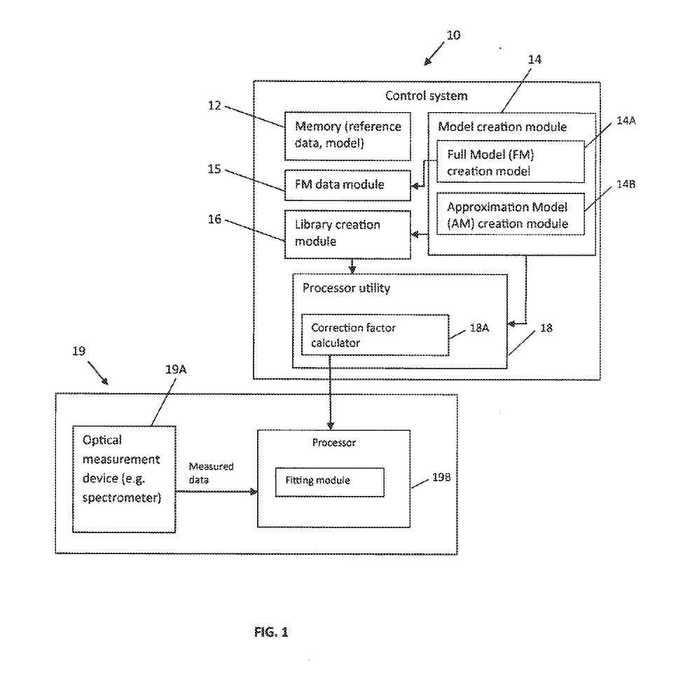

Reference is made to FIG. 1 illustrating by way of a block diagram a system of the invention, generally designated 10, configured and operable for creation of libraries for use in interpreting measured data from a complex structure. The system 10 is a computer system including such main functional utilities as a memory utility 12, a model creation module 14, a library creation module 16, an FM data creation module 15, and a processor utility 18. The model creation module 14 includes an FM creation unit 14A and an AM creation unit 14B. The processor utility 18 includes a correction factor calculator 18A configured for determining a relation (e.g. difference) between the FM and AM.

The correction factor, as well as the AM library, is then used by a processor 19B (its fitting utility), which is typically a part of a measurement system 19, for determining the structure parameters by fitting measured data to data determined as a certain function of the AM and the correction factor (e.g. a sum of the AM and correction factor). The measured data may be received directly from a measurement device 19A (on line or real time mode) or from a storage system as the case may be (off line mode).

The FM actually includes a set of parameters which is selected in accordance with a type of structure that is to be measured and possibly also the type of measurement technique being used. The parameters of the problem are usually geometrical dimensions but can include other factors describing for example material properties and/or types of measurements. It should be noted that the FM creation module 14A may be configured and operable for actual modeling of the measurement procedure applied to a specific structure, or may be operable to access a database in a storage device (e.g. memory utility 12 or an external storage system) for obtaining/selecting the appropriate data (parameters set) for the FM for a specific application.

The AM includes a smaller parameters' set which is entirely included in the FM. In other words, the parametric space of the AM forms a part of the parametric space of the FM.

The AM creation module 14B may be configured for actual modeling of the parameters' set for AM to satisfy a predetermined condition or may be operable to access a models' database in a storage system (memory 14A or an external storage) to obtain/select one or more suitable AMs, i.e. satisfying a predetermined condition. The condition to be satisfied by the selected AM is that, for a given FM, a relation between the AM and FM can be well defined, i.e. can be characterized by a well defined function, e.g. a linear function. In the simplest case, a relation between the FM and AM is a difference, Δ, between them. For simplicity, the term “Δ” will be used hereinbelow to indicate a function describing a relation between the FM and AM. Thus,

FM(x)=AM(x)+[FM(x)−AM(x)] (1)

or

FM((x))=AM((x))+Δ((x)) (2)

where x corresponds to location in the parametric space.

Equations (1) and (2) present an example of the basic/principal equation for the decomposition method, which can be generalized as follows:

FM((x))=f[(AM((x))] (3)

Generally, a library typically includes a set of functions (or values as the case may be) corresponding to the type of data to be measured from a specific structure, each function corresponding to a different values of the model parameters. According to the invention, there is no need for creation of any library with respect to the FM (neither “dense” nor sparse library for the FM data is needed), but rather the FM data creation module 15 operates to create FM related data including some functions/values of the type of data to be measured from the structure using the FM in selected points of the parametric space. Generally, such FM data may be considered as a very sparse library. This will be described more specifically further below. As for the AM, the full library (relatively) is to be used, i.e. for the entire parametric space of the approximation model (desired range of parameters of interest, and with a desired resolution). Thus, the library creation module 16 is configured and operable for creating the full library for the AM. The selected points of the parametric space used for the creation of the FM data are those included in the parametric space of AM. The processor utility 18 (and/or the library creation module 16) is configured and operable for determining a relation between the FM and AM in said selected points of the parametric space, and the processor is further operable for using this so-called “sparse relation” for interpreting measured data. This will be exemplified more specifically further below.

Considering for example optical spectrometric measurements on a patterned structure (e.g. semiconductor wafer), the meaning of the above is that the spectrum (or another diffraction signature, e.g. angular-resolved, complex electrical field amplitude, to etc.) calculated using the full model, S_{Full}(x), in location x in the parameter space, and the spectrum (or another diffraction signature) calculated using the approximate model for the same location x, S_{App}(x), in the parameter space are related to one another as follows:

S_{Full}(x)=S_{App}(x)+[S_{Full}(x)−S_{App}(x)] (4)

leading to the governing equations of the decomposition method for this specific example:

S_{Full}(x)≅S_{App}(x)+Δ(x₀) (5)

Δ(x₀)≡S_{Full}(x₀)−S_{App}(x₀) (6)

defining Δ(x₀) as the difference between the two models, FM and AM, calculated at a near-by position x₀ in the parameter space or using an interpolation on a (possibly sparse) library; the difference Δ is calculated not in the same point because it is sparser.

In other words, in order to calculate Δ, the full model spectrum S_{Full} and the approximate model spectra S_{App} (and further difference between them) are to be determined over sparser sampling in parameter space. Thus, according to the present invention, two spectral libraries are calculated: the library creation module 16 calculates the full library for the approximate model, and the processor 18 and/or module 16 determine the sparse library for the difference Δ.

Reference is now made to FIG. 2 showing a flow diagram 100 exemplifying a decomposition method of the present invention for use in measuring in complex patterned structures. First, the FM and AM (at least one AM) are created (steps 102 and 104) corresponding to a specific measurement technique applied to a specific type of structure, where the AM covers a parametric space PS being a part of parametric space PS_{full} of the FM and the AM satisfies a condition of equation (3) above with respect to the FM.

Then, the AM library and FM related data are created (steps 106 and 108). The AM library covers the entire parametric space PS of the AM. The FM data corresponds to a selected part or points x₀ of the parametric space PS (a certain set of parameters' values). Assuming that the AM conserves the larger part of the sensitivity of the FM to the main parameters, the library for the AM is first created, obtaining the required interpolation accuracy within this library. On the other hand, since the AM requires significantly shorter calculation time per point than the FM (as AM is defined by smaller parameter's set), the total calculation time for the AM library and the FM data is significantly reduced as compared to that for the full (dense) library creation for the FM as used in the conventional techniques.

Having determined the AM library for PS (step 106) and the FM data for points x₀ of PS (step 108), the system (processor and/or library creation module) operates to calculate a “sparse” library for the correction term Δ(x₀), step 110, enabling determination of a full library for Δ(x) to a similar interpolation accuracy. As much as the AM indeed closely resembles the FM, the values of Δ will be both small and slowly varying with the problem parameters, hence the required library for Δ will be much sparser than that for the AM. It should be noted that in the final result of equation (5) above, the errors of both terms are added, hence this should be taken into account when setting the target accuracy of each term.

Upon receiving actual measured data (e.g. spectral response S from a certain structure) from a measurement device or from a storage device, the measured data is fitted to respective data being determined by the system as (S_{App}(x)+Δ(x₀))−step 112. When the best fit is identified (step 114), the respective function is used for determining corresponding parameters of the structure (step 116).

Comparing the total calculation time using the decomposition approach of the present invention to the standard approach, the inventors have found that although in the decomposition approach two libraries are generated (for AM and Δ), the time needed for creation of each one of these libraries is significantly shorter than that required by the standard procedure utilizing the full library creation for FM. Indeed, the AM library creation is faster due to the simpler model, and the Δ library creation is relatively fast due to the lower number of required points. Since in many cases the differences between the faster and slower libraries can be an order of magnitude or more, the total effort for two faster libraries can still be shorter by a significant factor than building one longer library.

The following are some examples of the technique of the invention. It should be noted that applying the invented approach to all or at least some of the cases could be implemented while keeping substantially the same software/hardware system configuration.

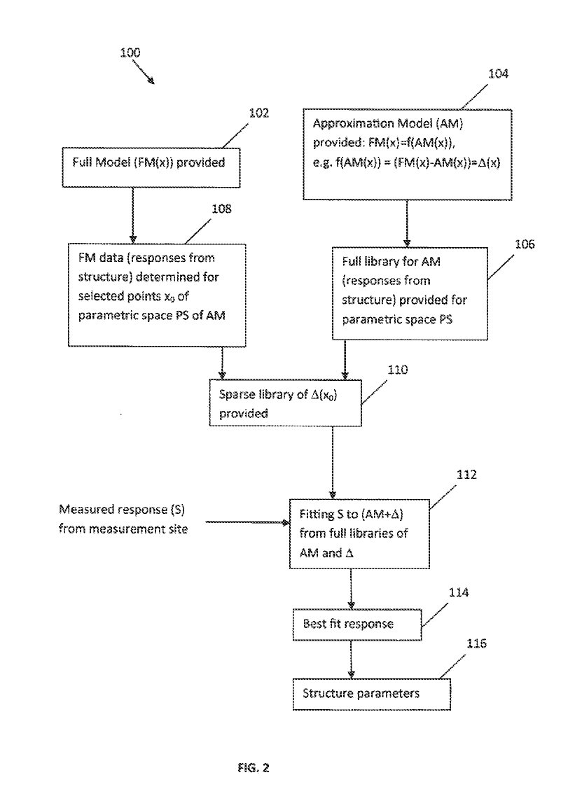

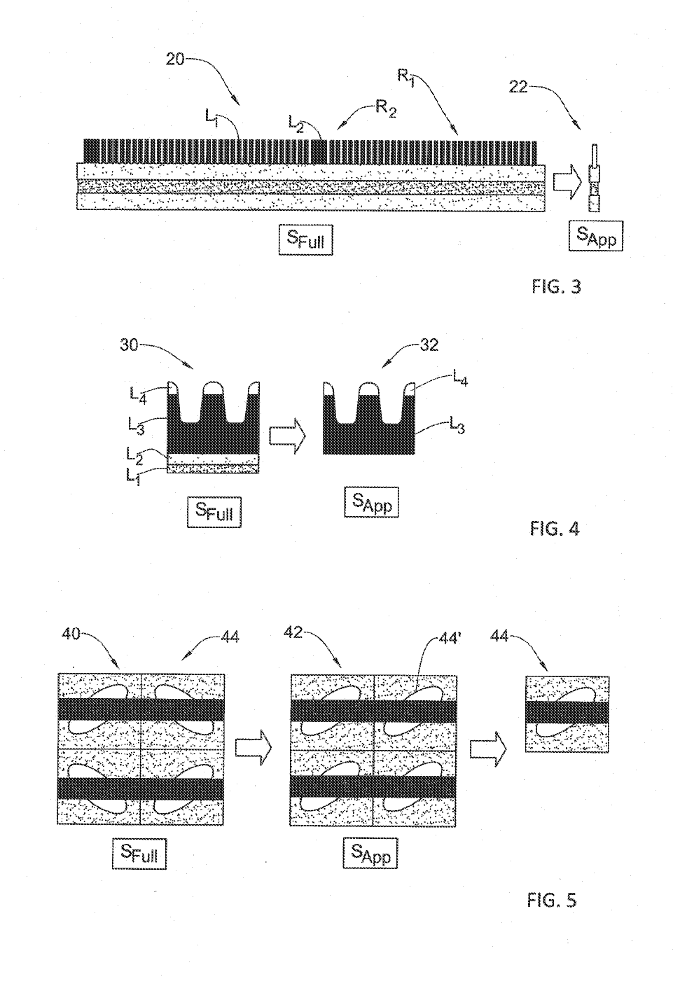

Reference is made to FIG. 3 exemplifying the decomposition method of the invention utilizing lateral separation. In this example, a complex structure 20 is approximated using a simpler structure 22 having a much shorter period. The typical example is an in-die application where the repetition of a memory cell creates a short periodicity while in order to correctly model the whole structure also some longer periodicity features have to be taken into account.

As shown, a pattern in the complex structure 20 includes patterned regions R₁, each being formed by an array of relatively small features (thin lines) L₁, which are spaced by a patterned region R₂ including a relatively large feature (thick line) L₂. Thus, the spectral response being measured and interpreted is a response S_{Full} from the complex structure 20. In this case, the AM is the model relating only to thin lines L₁, omitting the wider lines, therefore significantly reducing the period, e.g. by factor ˜x40 in the present example; and the AM library includes responses S_{App} from the structure 22. The shorter period structure 22 requires less diffraction modes to be modeled, hence the AM library has dramatically shorter calculation time. So, by calculating the difference between the measured data from full structure 20 and from the simplified structure 22 for a small number of points in the process range (sparse library) and interpolating between them, the correction term (difference) Δ appears to be in a sufficiently good accuracy, while utilizing creation of the full (denser) library only for the simplified model. Since all user parameters of interest are part of the simplified model, the sensitivities are kept as-is.

Thus, in this example of FIG. 3, the FM related data, S_{Full}, corresponds to the structure 20 of long period; the AM related data, S_{App}, corresponds to structure 22 with shorter period, and the correction term, Δ, adds the effect due to the small region of deviation from the short periodicity.

Reference is made to FIG. 4, which exemplifies the decomposition method of the invention for structures having vertical interaction of buried (patterned) underneath layers. Here, a complex structure under measurements is a structure 30 in the form of a stack including four layers L₁-L₄, and measured data to be interpreted is a spectral response S_{Full} from such structure 30. In the structure 30, layers L₁ and L₂ are planar layers with no pattern, while layers L₃ and L₄ are patterned layers: layer L₃ has a surface relief, while layer L₄ is in the form of a grating (discrete spaced-apart regions).

In many cases, the source of complexity in the application is due to the fact that in addition to the grating in the upper level which is intended to be controlled (last process step), there is additional underneath structure, e.g. comprising plurality of solid or patterned buried layers. The buried layer(s) typically could comprise grating formed by lines of a different orientation, e.g. having an orthogonal direction to the upper lines as in so-called “crossed-lines” applications. Presence of such underneath structure leads to a complex 3D application, while the upper level by itself could be considered either 2D or a simpler 3D application.

In this case, the underneath structure is replaced by an “effective” solid layer. Hence, approximation model refers to a simpler structure 32 in which layers L₁ and L₂ are omitted, and the AM library includes spectral response S_{App} from structure 32. Here, the underneath structure L₁-L₃ is replaced by “effective” solid layer L₃. In many cases, where the detected signal is mainly defined by the upper level and the effect of the underneath structure is relatively small, this solid layer serves as a 1st-order approximation. By itself “effective medium” approximation rarely provides sufficiently good fitting, however, using the decomposition method of the invention, correcting for the differences using an exact full model calculated on a smaller number of points, this could very well serve for an accurate-enough calculation, making the library computation dramatically quicker. Thus, in this example, the full-model spectrum determination S_{Full} is a 3D application, the determination of the AM library responses S_{App} is 2D application or a simpler 3D application, and the correction term Δ in this case is a small deviation from 2D, created by underneath structure.

Reference is made to FIG. 5 exemplifying the decomposition method of the invention based on the use of a reduced unit cell. In this example, a complex structure 40 that is to be measured includes four elements 44 in the form of ellipses (e.g. corresponding to STI islands) oriented along two intersecting axes. This complex structure 40 is approximated by a simpler structure 42 in which the ellipses 44′ are of the same size and general accommodation as in the structure 40 but with homogeneous alignment.

In some cases complex geometry of 3D structures requires usage of large and complicated 3D unit cell, that in turn makes calculation time very long. By using some simplification of the unit cell, e.g. a cell of smaller size, calculation time could be reduced. In the example of FIG. 5, by flipping the orientation of two ellipses 44 (to flip the orientation of the main axis of ellipse), the approximating structure 42 becomes much simpler because it defines a unit cell 44 which is smaller by factor x4 than the structure 40 and could thus sufficiently save computation time. Correction to the true full structure, assumed small, will be calculated for a small number of points. Thus, here, the full-model data, S_{Full}, has larger unit cell, the approximated data S_{App} is that of the smaller unit cell corresponding to the sub-cell of the larger cell, and correction term Δ describes the small aperiodicity in the larger cell.

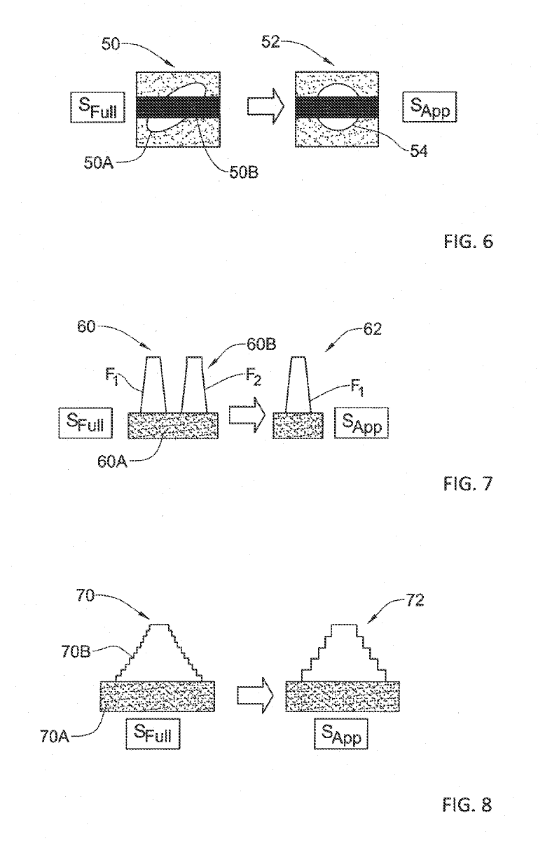

Referring to FIG. 6, there is illustrated yet another example of the decomposition method of the invention based on the use of improved symmetry of the structure. As shown, the structure 50 under measurements has a unit cell include an elliptical inclined feature 50A and a crossing horizontal line feature 50B. In the approximated structure 52, the ellipse is replaced by a circle 54. The spectral response S_{Full} from the complex structure 50 is a (somewhat) asymmetric function. Thus, the function describing spectral response S_{App} from the approximated structure 52 has higher symmetry than S_{Full}. Correction term, Δ, here describes the small asymmetry of the pattern.

FIG. 7 illustrates how the technique of the present invention can be used for measuring in structures having so-called double patterning configuration. For double patterning applications, a simplified model does not take into account some unintentional differences between the two steps of the double patterning process. The example of FIG. 7 is generally similar to a combination of the above described examples of FIGS. 5 and 6. In this example, a complicated structure 60 is in the form of a substrate 60A carrying a patterned layer 60B, where the pattern is in the form of an array of features, where each two adjacent features F₁ and F₂ have slightly different geometries. The spectral response S_{Full} from the complex structure 60 is a (somewhat) asymmetric function. The approximated structure 62 includes one of the different feature, F₁, being that of a simpler geometry. Accordingly, the spectral response, S_{Full}, corresponds to a to structure of a larger unit cell/period, while the spectral response, Sₐₚₚ, from the approximated structure corresponds to a structure of a smaller cell/period, and correction term, Δ, describes small variations between two stages of double patterning process.

FIG. 8 illustrates how the decomposition method of the invention may utilize rough approximation of profile with lower number of slicing. In some cases the number of slices required for appropriate approximation of non-rectangular cross-sectional profiles (taking into account weak profile parameters, e.g. Side Wall Angle (SWA), etc.) could dramatically increase the calculation time over a square profile. A structure 70 shown in FIG. 8 has a substrate 70A carrying a multi-layer structure 70B each layer having a different pattern (grating). e.g. a pattern feature of a gradually decreasing size towards the uppermost layer. The original structure 70 is approximated by a structure 72, where each two adjacent layers of structure 70B are replaced by a single layer, thus forming limited number of “thicker” slices for first-order approximation, and correction sparsely for “fine” profile parameters provides for saving calculation time. Accordingly, a spectral response, S_{Full}, from a complex structure has full spatial resolution along z-axis (vertical), while the response, S_{App}, from the approximated structure has reduced spatial resolution along the z-axis, and the correction term describes the small contribution of finer slices.

In some other embodiments, the invention can utilize approximation of high/low spatial resolution of cross-sectional profiles along x- and/or y-axis. Here, similar to the previous case, the cross-sectional profiles along x- and/or y-axis could be approximated with reduced spatial resolution. Assuming the lower spatial resolution contains the majority of the sensitivity to the parameters, a low-density correction could allow getting to the required final spectral accuracy in a much smaller total calculation time. Thus, the modeled response, S_{Full}, from the complex structure has full spatial resolution along x-y axes, while the modeled response, S_{App}, from the approximated structure has reduced spatial resolution along x-y axes, the correction term describing the contribution of finer spatial resolution along x-y axes.

The above-described non-limiting examples of the invention deal mainly with the model parameters representing patterned structure to be measured. The invention can also be used for appropriately approximating the measurement procedure itself, for example, the type of measured response, e.g. diffraction pattern of the collected response (e.g. number of diffraction orders being collected).

The following are some non-limiting examples generally describing how the present invention can utilize the model parameters characterizing interaction of electromagnetic waves with the patterned structure to be measured (illumination and/or reflection from the measured structure), or relating to the measurement technique itself.

For example, the use of low spectral setting (resolution) yielding low accuracy of the spectral calculation, could be useful approximation. Assuming the lower spectral setting contains the majority of the sensitivity to the parameters, a low-density correction could allow getting to the required final spectral accuracy in a much smaller total calculation time. The modeled response, S_{Full}, from the structure used in actual measurements has high (or full) spectral resolution, while the modeled approximated response S_{App} has reduced spectral resolution, in which case the correction term corresponds to a small contribution of higher spectral resolution (accuracy).

In some cases, using different numerical aperture of light collection (divergence angle) required to characterize the profile parameters increases the calculation time. Thus, by taking just one (or, generally, minimal number of) numerical aperture value (angle) as the first-order approximation, and applying sparsely the correction for the remaining numerical aperture sensitivity, the calculation time can be reduced. Yet another possible example is by using symmetric numerical aperture distribution for oblique channel as the approximate model and taking into account the asymmetry as a correction term. In these examples, the full model for measure data, S_{Full}, is sensitive to a change in the numerical aperture, while the approximated model, S_{App}, corresponds to the single (minimal number of/symmetric) numerical aperture that accounts for some (most) part of the spectrum. The correction term corresponds to relatively small contribution of non-zero/non-symmetric numerical apertures.

As indicated above, the invention can base the approximation of a lower number of diffraction orders. Calculation time could increase exponentially with the increase in the number of retained orders (diffraction modes). It is possible to take decreased number of diffraction orders, e.g. lower diffraction orders, as the initial approximation and further perform a sparsely correction for contribution of higher diffraction orders. The modeled measured data, S_{Full}, has high (“full”) number of diffraction modes, the approximated measured data, S_{App}, has limited number of diffraction modes, and the correction term is a small contribution of higher diffraction modes.

It should be understood that the invention is not limited to the type of a structure being measured, not limited to the type of measurements (spectral measurements is just an example), as well as is not limited to a number of approximation models. Generally, according to the invention, at least two models are created for the same measurement site in a structure, one being the full (or sufficient) model, and at least one other model being the approximate model. The accuracy requirements of measurements are decomposed into two parts: approximation and correction (typically both parts could contribute into accuracy budget equally). An error-controlled library for the approximate model, and an error-controlled library for the correction term (relation, e.g. difference between the full model and the approximate model) are created. Then, when using the library for the interpretation, data (e.g. spectra) in both libraries are interpolated and the results are added.

In some embodiments of the present invention, is a possible to combine two or even more approximations for the same application. Thus, for application presented in FIG. 3, in addition to lateral separation, for example vertical interaction (example of FIG. 4), lower slicing (example of FIG. 8) and high/Low spectral accuracy (resolution) described above, could be applied. While various methods are possible, for the sake of simplicity of implementation and final accuracy, it might be preferable to place all selected approximations into a single approximate model, for example a model containing both lateral separation and lower high/Low spectral accuracy (resolution).

As in any case of application development, the quality of the solution preferably could be tested in order to verify the used approximations are valid. This could be done either by running a few examples through the decomposition model and full real-time regression, or alternatively by comparing direct calculation at some test points to their interpolated equivalents (adding both contributions, clearly) and comparing to the target spectral accuracy of the library.

Also, according to the invention, the library calculation can be combined with real time regression using the above-described technique. In this case, the decomposition into a full model and an approximate model is done in the same way, as described above. A library is built for the correction term (difference), Δ, and stored in memory of the system (or external storage system accessible by the system). During the real time measurements, the approximate model is calculated at each iteration step of the regression cycle and is corrected by an interpolated value taken from the correction library. This technique enables to use the real time regression in cases where the full calculation is too long to be completed in real time with the available computation power.

1. A method for use in measuring in complex patterned structures, the method comprising:
providing a full model and at least one approximate model for the same measurement site in a structure, said at least one approximate model satisfying a condition that a relation between the full model and the approximate model is defined by a predetermined function;
creating a library for simulated data calculated by the approximate model for the entire parametric space of the approximate model;
determining data corresponding to simulated data calculated by the full model in selected points of said parametric space;
utilizing said library for the approximate model and said data of the full model and creating a library of values of a correction term for said parametric space, the correction term being determined as said predetermined function of the relation between the full model and the approximate model, thereby enabling to process measured data by fitting said measured data to the simulated data calculated by the approximate model corrected by a corresponding value of the correction term.

2. The method of claim 1, wherein said predetermined function, defining the relation between the full model and the approximate model, is a smooth function.

3. The method of claim 1, wherein said predetermined function, defining the relation between the full model and the approximate model, is a linear function.

4. The method of claim 1, wherein said predetermined function, defining the relation between the full model and the approximate model, is a difference between values of the full model and the approximate model.

5. The method of any one of the preceding claims, wherein the creation of the library for correction term values in said parametric space comprises: using said library for the approximate model and said data of the full model and calculating values of the correction term for said selected points of the parametric space; utilizing said predetermined function defining the relation between the full model and the approximate model and calculating values of the correction term for the entire parametric space of the approximate model.

6. The method of any one of the preceding claims, wherein the approximate model and the full model include parameters characterizing the structure under measurements.

7. The method of claim 6, wherein the approximate model is configured for approximating a complex patterned structure, having two or more patterns with different periods, by a structure having a pattern with a shorter period.

8. The method of claim 6, wherein the approximate model is configured for approximating a complex patterned structure, having multiple layers including top patterned layers, by a structure in which at least one underneath unpatterned layer is omitted.

9. The method of claim 6, wherein the approximate model is configured for approximating a complex patterned structure by a structure having a reduced unit cell.

10. The method of claim 9, wherein said reduced unit cell has homogeneous alignment of elements similar to those of a unit cell in the complex structure to be measured.

11. The method of claim 9 or 10, wherein said reduced unit cell has a smaller size than a corresponding unit cell in the complex structure to be measured.

12. The method of claim 6, wherein the approximate model is configured for approximating a complex patterned structure by a structure with improved symmetry of a unit cell.

13. The method of any one of the preceding claims, wherein the approximation model and the full model include parameters characterizing measurements for obtaining the measured data.

14. The method of claim 13, wherein the measurements include optical measurements, said parameters characterize interaction of light with the patterned structure to be measured.

15. The method of claim 14, wherein the approximate model is configured for approximating measurements by using a relatively low spectral setting, the simulated data calculated by the approximate model having reduced spectral resolution, the correction term corresponding to a small contribution of higher spectral resolution.

16. The method of claim 14, wherein the approximate model is configured for approximating measurements by using a different numerical aperture of collection of light from the structure such that the simulated data calculated by the approximate model corresponds to a minimal number of the numerical aperture that accounts for most part of the collected light, the correction term corresponding to relatively small contribution of non-zero numerical apertures.

17. The method of claim 14, wherein the approximate model is configured for approximating measurements by using a lower number of diffraction orders, the correction term corresponding to a small contribution of higher diffraction modes.

18. A system for use in measuring in complex patterned structures, the system comprising:
a modeling utility for providing a full model and at least one approximate model for the same measurement site in a structure, wherein said at least one approximate model satisfies a condition that a relation between the full model and the approximate model is defined by a predetermined function;
a library creation module configured and operable for determining and storing simulated data calculated by the approximate model for the entire parametric space of the approximate model;
a full data module configured and operable for determining and storing data corresponding to simulated data calculated by the full model in selected points of said parametric space;
a processor utility configured and operable for utilizing said library for the approximate model and said data of the full model and creating a library of values of a correction term for said parametric space, the correction term being determined as said predetermined function of the relation between the full model and the approximate model;
the system thereby enabling processing of measured data by fitting said measured data to the simulated data calculated by the approximate model and corrected by a corresponding value of the correction term.
